(19) United States
(12) Patent Application Publication
(10) Pub. No.: US 2013/0141906 A1
(43) Pub. Date: Jun. 6, 2013

(54) Reflective LED lighting lamp structure and lighting device

(71) Applicants: Yinghua Wang, Shanghai (CN); Ming Chen, Shanghai (CN); Ye Ye, Shanghai (CN); Haibiao Zhu, Shanghai (CN)

(72) Inventors: Yinghua Wang, Shanghai (CN); Ming Chen, Shanghai (CN); Ye Ye, Shanghai (CN); Haibiao Zhu, Shanghai (CN)

(73) Assignees: Shanghai Sansi Electronics Engineering Co., Ltd.; Jiashan Sansi Photoelectric Technology Co., Ltd.; Shanghai Sansi Technology Co., Ltd.

(21) Appl. No.: 13/492,867

(22) Filed: Jun. 10, 2012

(30) Foreign Application Priority Data
Dec. 2, 2011 (CN) 201110449092.8

(51) Int. Cl. F21V 7/00; F21V 29/00

(52) U.S. Cl. 362/235

(57) ABSTRACT

A reflective LED lighting lamp includes a lamp housing and a light source module strip mounted to the lamp housing. A reflective layer mounted to the lamp housing. The light source module strip has an independently removable one-piece structure and includes at least one LED light source and an LED light source mounting base. The LED light source mounting base is inserted into the lamp housing by a slot. The LED light source mounting base is made of thermal conductive material. The heat generated by the LED is transmitted to the lamp housing by the LED light source mounting base, and then is dissipated by the lamp housing. The present invention adopts the one-piece light source module strip. Installation and disassembly by simple insert-pullout manner between the LED light source module strip and the lamp housing can be achieved. The present invention has simple operation and strong applicability.

### BACKGROUND OF THE PRESENT INVENTION

1. Field of Invention

The present invention relates to the LED (light emitting diode) lighting field, and more particularly to a reflective LED lighting lamp structure and an LED lighting device.

2. Description of Related Arts

As the lighting source, LEDs have the advantages of energy saving, environmental protection and high efficiency. However, due to the concentrating characteristic under small size and high brightness, the serious glare issue will be produced while perpendicular incidence. The light is not soft, thereby resulting in the uncomfortable sense for human eyes. The glare issue can be effectively resolved by the surface light source instead of LED point light source. Accordingly, the reflective LED lighting lamp appears. A layer of reflective film is attached to the lamp housing for reflecting light in the currently reflective LED lighting lamp on the market. In the lamp mentioned above, the LED light source is fastened to the lamp housing by a plurality of screws. It has complex installation process, and especially for large lamps, time and energy are consumed. Moreover, the installation dislocation easily appears during the tightening process of the screw. It is more seriously to damage the light source. Meanwhile, while disassembling and maintaining the lamp, it is inconvenient to disassemble the LED light source on the spot. Furthermore, at some application occasions which have the higher requirements for the protection level of the lamp, the lamp housing must adopt the special structure. For example, when the lamp housing has a closed structure, the method which tightens the screws at different positions of the inner of the lamp housing can not be achieved.

### SUMMARY OF THE PRESENT INVENTION

An object of the present invention is to provide a reflective LED lighting lamp, which adopts the one-piece light source structure, is convenient for installation and disassembly by simple insert-pullout manner between the LED light source module strip and the lamp housing, and has simple operation and strong applicability.

Another object of the present invention is to provide an LED lighting device which is formed by a plurality of reflective LED lighting lamps mentioned above connected with each other in series. Accordingly, the LED lighting device has various shapes for meeting a variety of application requirements of lighting and landscape.

Accordingly, in order to accomplish the above objects, the present invention provides a reflective LED (light emitting diode) lighting lamp, comprising a lamp housing, a light source module strip mounted to the lamp housing, and a reflective layer mounted to the lamp housing, wherein the light source module strip of the LED lighting lamp has an independently removable one-piece structure and comprises at least one LED light source and an LED light source mounting base for mounting the LED light source, the LED light source mounting base and the lamp housing are two long strip tensile profiles, and the LED light source mounting base is inserted into the lamp housing for connecting and fastened to each other by a slot.

Preferably, the light source module strip further comprises a circuit board mounted to the LED light source mounting base for welding the LED light source.

Preferably, the lamp housing, having an arched structure, comprises an arched part with a closed longitudinally sectional contour line, and a reflective film is attached to an inner sidewall of the arched part, or the inner sidewall of the arched part is coated with a layer of reflective material.

Preferably, the LED light source mounting base matches the lamp housing.

Preferably, the slot is provided at an inner side end of the arched structure or the LED light source mounting base along the tensile direction thereof.

Preferably, the slot is provided at two opposite side ends of the arched structure or the LED light source mounting base along the tensile direction thereof.

Preferably, the slot is provided at a side end of the arched structure or the LED light source mounting base along the tensile direction thereof.

Preferably, the lamp housing comprises two or more arched structures connected with each other side by side.

Preferably, the two arched structures are connected with each other by a connector of long strip tensile profile, and the slot is provided at a tensile direction of the connector for respectively inserting the lamp housing and the LED light source mounting base.

Preferably, the light source module strip is mounted, and then two ends of the lamp housing are further fastened by two covers, respectively.

Preferably, the lamp housing and the LED light source mounting base are made of aluminum or thermally conductive plastics.

An LED lighting device is formed by a plurality of reflective LED lighting lamps mentioned above connected with each other in series.

The LED lighting device is rectangle, square, curved, circular or S-shaped.

The beneficial effects of the present invention are described as follows.

The reflective LED lighting lamp provided by the present invention comprises two independently removable parts, namely, the lamp housing and the light source module strip. The light source module strip, having a one-piece structure, comprises the LED light source and the LED light source mounting base. The lamp housing and the light source module strip are directly connected with each other or connected with other by the connecting piece. Furthermore, the light source module strip is inserted into the lamp housing by a slot. Therefore, the installation and disassembly by simple insert-pullout manner between the LED light source module strip and the lamp housing can be achieved. The present invention has simple operation and strong applicability, and is capable of effectively improving the production efficiency of the product. While disassembling and maintaining the lamp, there is no need for independently disassembling the LED light source, thereby avoiding the damage to the LED light source during the disassembling process. Moreover, when the lamp housing has a closed structure with a higher protection level, the installation and disassembly of every part of the lamp can be conveniently achieved by simple insert-pullout manner.

Furthermore, in the case of the same power, the slot is provided at one side, namely, the LED light source is provided at one side, compared with the condition that the LED light sources are provided at two sides, the mounting distance among the same number of LED light sources can be smaller, thereby the irradiation dark area can be effectively avoided when the distance between the light sources is larger. Accordingly, the light of the irradiated region is evener and softer.

These and other objectives, features, and advantages of the present invention will become apparent from the following detailed description, the accompanying drawings, and the appended claims.

### BRIEF DESCRIPTION OF THE DRAWINGS

FIG. 1 is a perspective view of an LED (light emitting diode) lighting lamp according to a first preferred embodiment of the present invention.

FIG. 2 is an exploded view of FIG. 1.

FIG. 3 is a sectional view of FIG. 1.

FIG. 4 is a perspective view of an LED (light emitting diode) lighting lamp according to a second preferred embodiment of the present invention.

FIG. 5 is a sectional view of two arched connection parts shown in FIG. 4.

FIG. 6 is a perspective view of an LED (light emitting diode) lighting device of the present invention.

### DETAILED DESCRIPTION OF THE PREFERRED EMBODIMENT

The present invention is further explained in detail with the accompanying drawings.

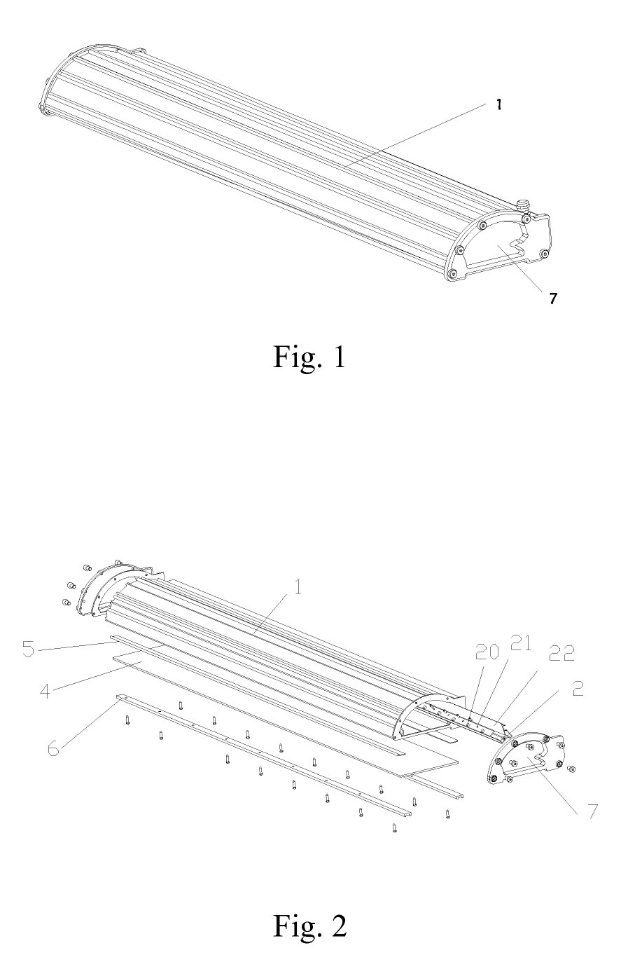

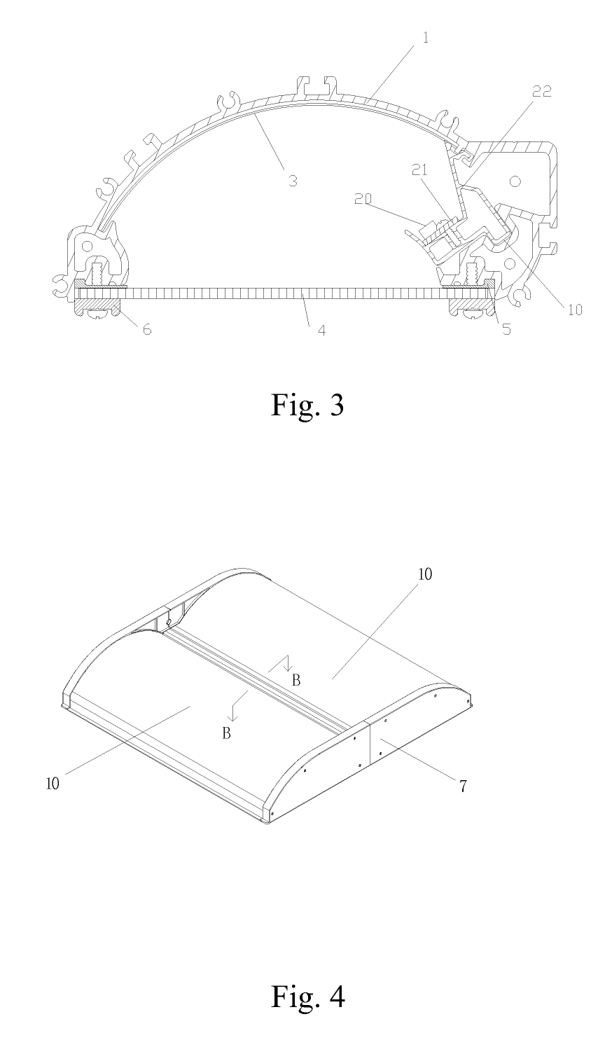

Referring to FIGS. 1 to 3 of the drawings, a reflective LED (light emitting diode) lighting lamp according to a first preferred embodiment of the present invention is illustrated, wherein the reflective LED lighting lamp comprises a lamp housing 1 and a light source module strip 2. The lamp housing 1, having an arched longitudinal section, is a long strip tensile aluminum profile. The arched part has a closed structure. A slot 10 is provided at a position near a bottom of the lamp housing 1 along a tensile direction thereof. The light source module strip 2 of the LED lighting lamp, having an independently removable one-piece structure, comprises at least one LED light source 20, and a circuit board 21 for welding the LED light source 20. The circuit board 21 is surface attached to an LED light source mounting base 22. Then, the LED light source mounting base 22 is inserted into the slot 10 of the lamp housing 1. To further improve the heat dissipation of the lighting lamp, a contact surface with a certain area is provided between the LED light source mounting base 22 and the lamp housing 1, thereby the heat generated by the light source module strip 2 is dissipated by the lamp housing 1. A reflective film 3 is attached to the inner wall of the arched part of the lamp housing 1. The relative position of the LED light sources 20 to the reflective film 3 and the camber of the arched part of the lamp housing 1 are determined by the existing lighting calculation software according to the actual requirements of illumination and lighting effects, such as dialux software (which is a design software applied to the lighting field and capable of accurately calculating and simulating the lighting effects) or other calculation software. The light source module strip 2 is inserted into the slot 10, and then a light transmission cover 4 is mounted to the lamp housing 1. A layer of silica gel gasket 5 is provided between the light transmission cover 4 and the lamp housing 1. Two external sides of the light transmission cover 4 are mounted to the lamp housing 1 by two press bars 6, respectively. Finally, two end covers 7 are respectively fastened to two openings at two ends of the lamp housing 1, so that the two openings are closed.

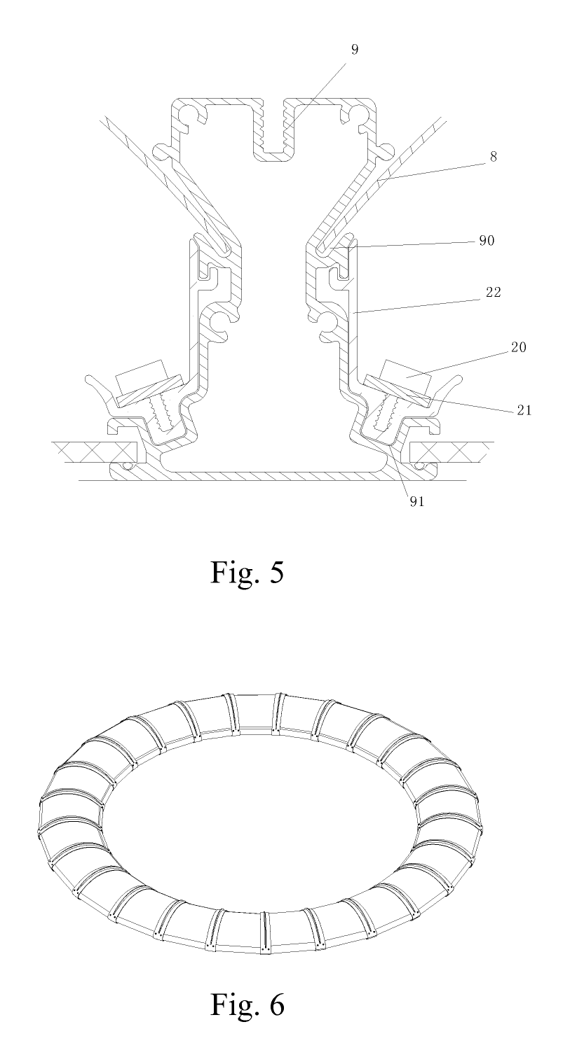

Referring to FIGS. 4 to 5 of the drawings, a reflective LED (light emitting diode) lighting lamp according to a second preferred embodiment of the present invention is illustrated. Different from the first preferred embodiment of the present invention, the lamp housing 8 of the reflective LED lighting lamp according to the second preferred embodiment of the present invention is formed by joining two arched structures side by side together. The two arched structures are connected with each other by a connector 9 of the long strip tensile aluminum profile. Two slots 90 and 91, which are adapted for respectively inserting the lamp housing 8 and the LED light source mounting base 22, are provided at one of two sides of the connector 9 along the tensile direction thereof. Two end covers 18 are respectively fastened to two ends of the lamp housing 8, so that the two arched structures are closed.

As shown in FIG. 6, an LED lighting device, having a circular shape, is formed by a plurality of reflective LED lighting lamps connected with each other in series according to the preferred embodiment of the present invention. According to actual needs, the specific shape of the connector between two adjacent LED lighting lamps can be designed, thereby obtaining large-scale LED lighting devices with various shapes through connecting with each other in series, such as long strip shape, arched shape and S shape.

One skilled in the art will understand that the embodiment of the present invention as shown in the drawings and described above is exemplary only and not intended to be limiting.

It will thus be seen that the objects of the present invention have been fully and effectively accomplished. Its embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A reflective LED (light emitting diode) lighting lamp, comprising a lamp housing, a light source module strip mounted to the lamp housing, and a reflective layer mounted to the lamp housing, wherein the light source module strip has an independently removable one-piece structure and comprises at least one LED light source and an LED light source mounting base for mounting the LED light source, the LED light source mounting base and the lamp housing are two long strip tensile profiles, and the LED light source mounting base is inserted into the lamp housing for connecting and fastened to each other by a slot.

2. The reflective LED lighting lamp, as recited in claim 1, wherein the light source module strip further comprises a circuit board mounted to the LED light source mounting base for welding the LED light source.

3. The reflective LED lighting lamp, as recited in claim 1, wherein the lamp housing, having an arched structure, comprises an arched part with a closed longitudinally sectional contour line, and a reflective film is attached to an inner sidewall of the arched part, or the inner sidewall of the arched part is coated with a layer of reflective material.

4. The reflective LED lighting lamp, as recited in claim 3, wherein the LED light source mounting base matches the lamp housing.

5. The reflective LED lighting lamp, as recited in claim 4, wherein the slot is provided at an inner side end of the arched structure or the LED light source mounting base along the tensile direction thereof.

6. The reflective LED lighting lamp, as recited in claim 5, wherein the slot is provided at two opposite side ends of the arched structure or the LED light source mounting base along the tensile direction thereof.

7. The reflective LED lighting lamp, as recited in claim 5, wherein the slot is provided at a side end of the arched structure or the LED light source mounting base along the tensile direction thereof.

8. The reflective LED lighting lamp, as recited in claim 3, wherein the lamp housing comprises two or more arched structures connected with each other side by side.

9. The reflective LED lighting lamp, as recited in claim 8, wherein the two arched structures are connected with each other by a connector of long strip tensile profile, and the slot is provided at a tensile direction of the connector for respectively inserting the lamp housing and the LED light source mounting base.

10. The reflective LED lighting lamp, as recited in claim 1, wherein the light source module strip is mounted, and then two ends of the lamp housing are further fastened by two covers, respectively.

11. The reflective LED lighting lamp, as recited in claim 1, wherein the lamp housing and the LED light source mounting base are made of aluminum or thermally conductive plastics.

12. An LED (light emitting diode) lighting device, comprising a plurality of reflective LED lighting lamps connected with each other in series, wherein each of the reflective LED lighting lamps comprises a lamp housing, a light source module strip mounted to the lamp housing, and a reflective layer mounted to the lamp housing, wherein the light source module strip has an independently removable one-piece structure and comprises at least one LED light source and an LED light source mounting base for mounting the LED light source, the LED light source mounting base and the lamp housing are two long strip tensile profiles, and the LED light source mounting base is inserted into the lamp housing for connecting and fastened to each other by a slot.

13. The LED lighting device, as recited in claim 12, wherein the light source module strip further comprises a circuit board mounted to the LED light source mounting base for welding the LED light source.

14. The LED lighting device, as recited in claim 12, wherein the lamp housing, having an arched structure, comprises an arched part with a closed longitudinally sectional contour line, and a reflective film is attached to an inner sidewall of the arched part, or inner sidewall of the arched part is coated with a layer of reflective material.

15. The LED lighting device, as recited in claim 14, wherein the slot is provided at an inner side end of the arched structure or the LED light source mounting base along the tensile direction thereof.

16. The LED lighting device, as recited in claim 15, wherein the slot is provided at two opposite side ends of the arched structure or the LED light source mounting base along the tensile direction thereof.

17. The LED lighting device, as recited in claim 15, wherein the slot is provided at a side end of the arched structure or the LED light source mounting base along the tensile direction thereof.

18. The LED lighting device, as recited in claim 14, wherein the lamp housing comprises two or more arched structures connected with each other side by side.

19. The LED lighting device, as recited in claim 18, wherein the two arched structures are connected with each other by a connector of long strip tensile profile, and the slot is provided at a tensile direction of the connector for respectively inserting the lamp housing and the LED light source mounting base.

20. The LED lighting device, as recited in claim 12, wherein the lamp housing and the LED light source mounting base are made of aluminum or thermally conductive plastics.
